(19) United States
(12) Patent Application Publication
(10) Pub. No.: US 2004/0035990 A1
(43) Pub. Date: Feb. 26, 2004

(54) Holder for presenting at least one elongate multi-purpose hand-held unit

(76) Inventor: Peter Ackeret, Kusnacht (CH)

Correspondence Address: Brinks Hofer Gilson & Lione, NBC Tower, Suite 3600, P O Box 10395, Chicago, IL, 60610, US

(21) Appl. No.: 10/311,836

(22) PCT Filed: Jun. 23, 2001
(86) PCT No.: PCT/EP01/07153

(30) Foreign Application Priority Data
Jun. 27, 2000 (DE) 10031314.0

(51) Int. Cl. F16M 11/00

(52) U.S. Cl. 248/176.1; 248/158

(57) ABSTRACT

The invention relates to a mount for displaying at least one elongate multipurpose hand-held implement (5), having a carrier (1) and an accommodating clamp (4) which is borne by said carrier and has an arm (6) which essentially follows the contour of the implement (5) and, at one end, has a nose (7) for being pushed into an opening on one end side of the implement (5) and, at the other end, has a U-shaped cradle (8) for laterally supporting the implement (5).

The invention relates to a mount for displaying at least one elongate multipurpose hand-held implement.

Such multipurpose hand-held implements, which are suitable for office work in particular, are known from WO 97/04924, WO 98/32570 and WO 99/20428, it being possible to provide, alongside a stapler and/or hole puncher, additional tools such as scissors, a knife blade, staple remover or the like.

The object of the invention is to provide a mount by means of which one or more such multipurpose hand-held implements can be displayed clearly and effectively.

This object is achieved in accordance with claim 1.

Further configurations of the invention can be gathered from the following description and the subclaims.

The invention is explained in more detail hereinbelow with reference to exemplary embodiments illustrated in the attached drawings, in which:

FIG. 1 shows a perspective view of a mount for displaying a multipurpose hand-held implement,

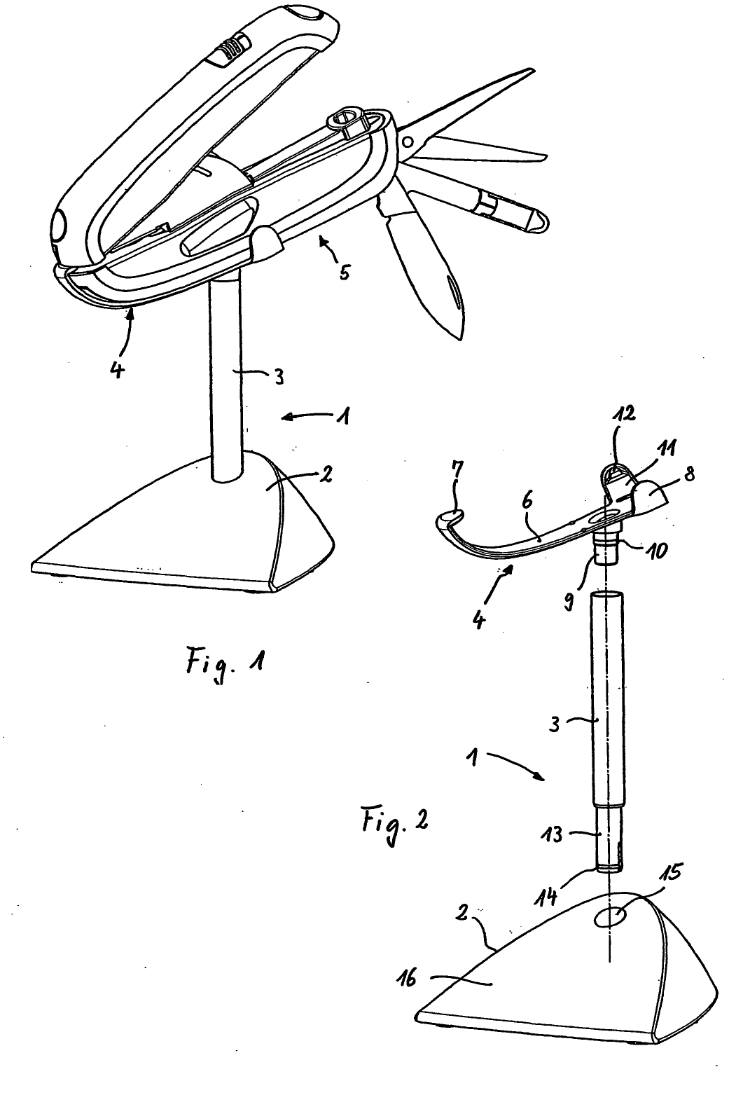

FIG. 2 shows an exploded illustration of the mount from FIG. 1,

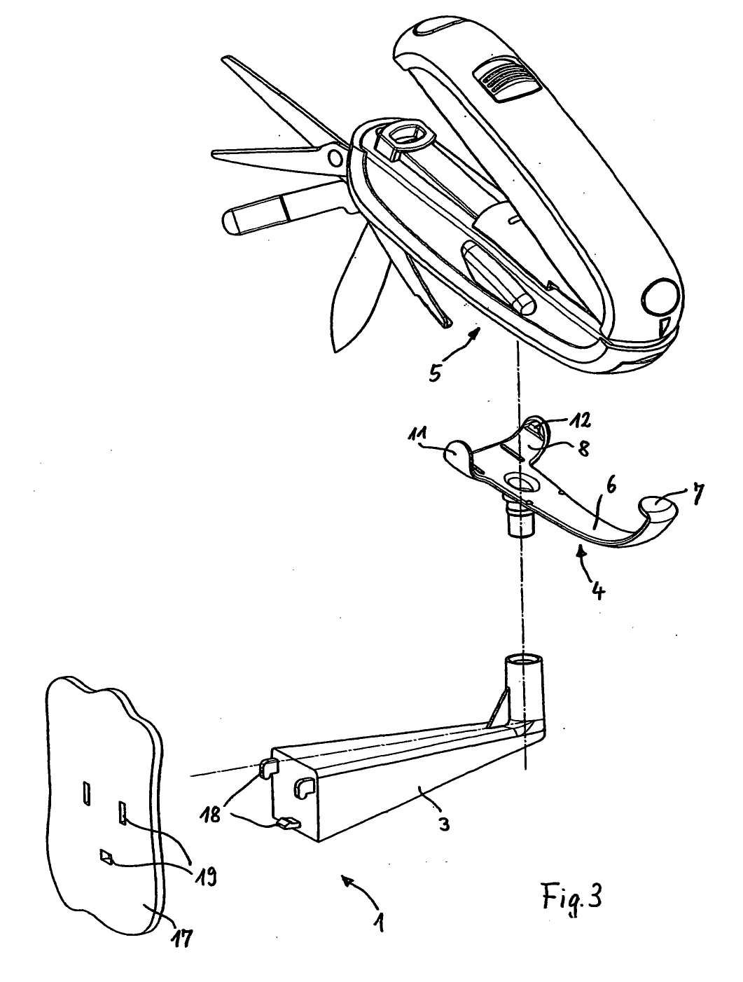

FIG. 3 shows an exploded illustration of a further embodiment of a mount,

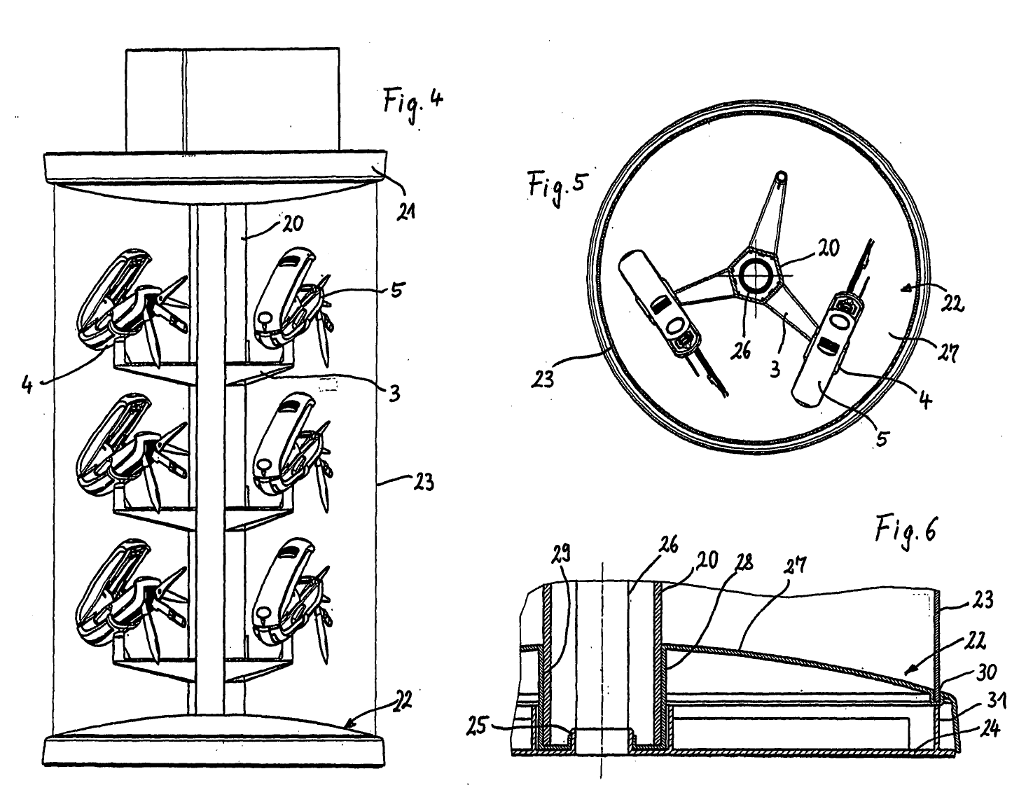

FIG. 4 shows a front view of a further embodiment of a mount for displaying a plurality of multipurpose hand-held implements,

FIG. 5 shows a radial section through the mount from FIG. 4,

FIG. 6 shows, in detail form, an axial section through the mount from FIG. 4,

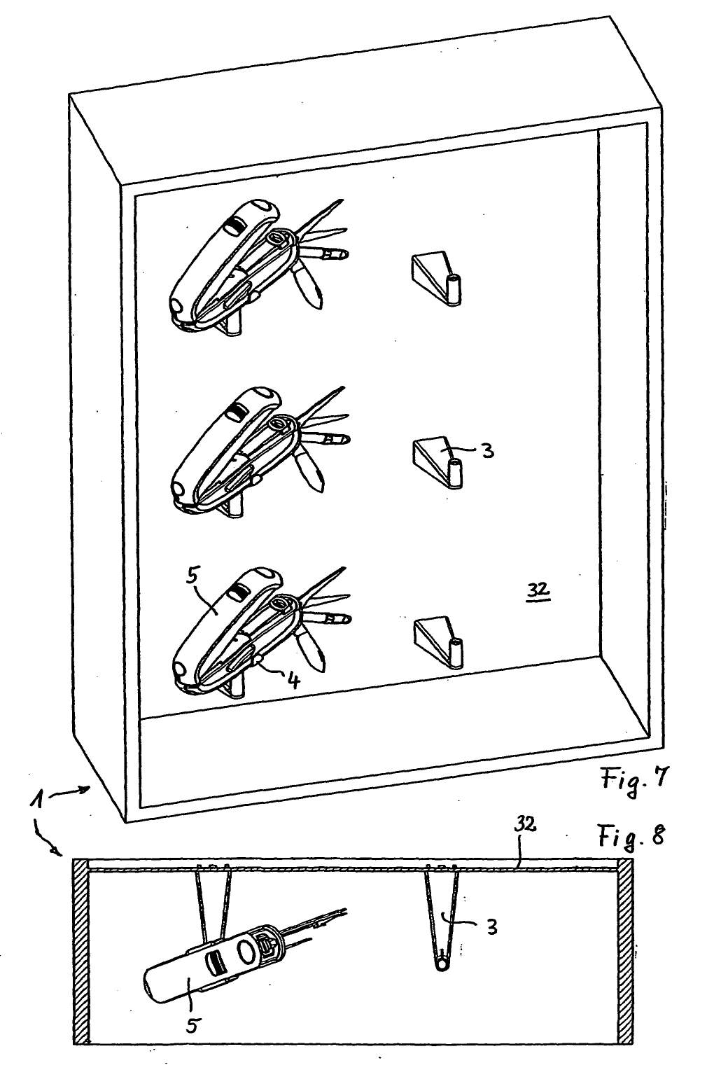

FIG. 7 shows a perspective view of a further embodiment of a mount for displaying a plurality of multipurpose hand-held implements,

FIG. 8 shows the mount from FIG. 7 in a horizontal section,

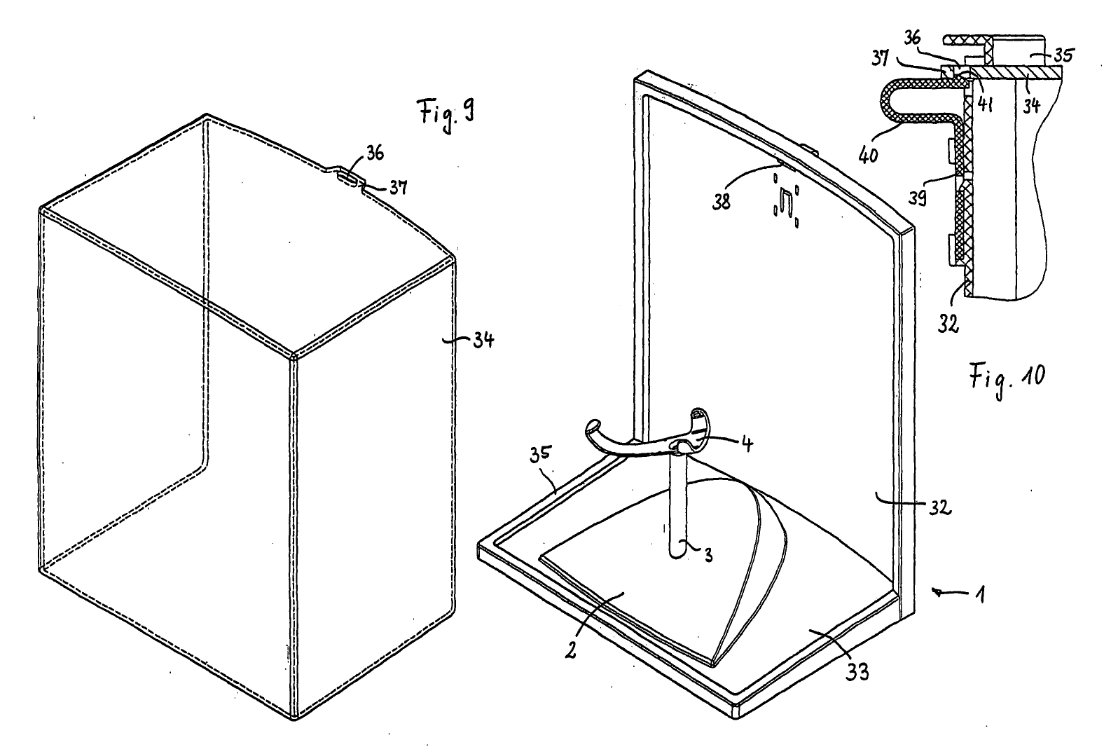

FIG. 9 shows the separate parts of an additional embodiment of a mount for displaying a multipurpose hand-held implement, and

FIG. 10 shows, in section, a detail of the mount from FIG. 9.

The mount illustrated in FIGS. 1 and 2 is made up of a carrier 1, which comprises a foot 2 and a support 3, which is tubular in the exemplary embodiment illustrated, and of an accommodating clamp 4 for an elongate multipurpose hand-held implement 5, in particular for office work, which, in the case illustrated, comprises a stapler, a hole puncher as well as scissors, a staple remover and a knife blade which can be used, inter alia, for opening letters.

The accommodating clamp 4 has an arm 6 which follows the contour of the implement 5, and, at one end, has a nose 7 for being pushed into an opening or a slot on one end side of the implement 5, and, at the other end, has a U-shaped cradle 8 for laterally supporting the implement 5.

The accommodating clamp 4 has on its underside, approximately centrally in relation to the implement 5, a hollow plug-in stub 9 for plugging into the tubular support 3, a collar 10 being provided on the plug-in stub. 9 in order to latch the plug-in stub 9 into a corresponding recess. The accommodating clamp 4 nevertheless remains rotatable in relation to the carrier 1.

Instead of this connection, it would also be possible, however, to provide a screw connection, a press-fit connection, a plug-in connection or the like or else a non-releasable connection such as an adhesive bond or a single-piece design of the accommodating clamp 4 end support 3.

The accommodating clamp 4 is expediently inclined, in relation to the horizontal, in the direction of the end bearing the nose 7, in order for the implement 5, which is only supported approximately up to the center, to be reliably accommodated and attractively displayed. The U-shaped cradle 8 preferably has legs 11 which are prestressed in relation to one another, in order for it to be possible for the implement 5 to be clamped in to some extent. The legs 11 are provided with inwardly directed noses 12 at their free ends for engaging with corresponding clearances in the implement 5. The elongate implement 5 illustrated has two components 5a, 5b which can be moved in relation to one another and each have planar side walls 5c and a housing shell 5d extending over the latter, with the result that the side walls 5c are set back in relation to the associated housing shell 5d, and the noses 12 engage in the recess. It is thus readily possible for the implement 5 to be inserted into the accommodating clamp 4, and removed from the same, without damage.

The foot 2 and support 3 of the carrier 1 can preferably be joined together. For this purpose, it is expedient if the support 3 is provided with a plug-in stub 13 which is sloped at the end and bears a bead 14 with the result that the plug-in stub 13 can be latched firmly in a corresponding hole 15 in the foot 2. Instead of this, it is also possible to provide other connections or a single-piece design of the foot 2 and support 3.

The foot 2 has, in particular, a sloping display surface 16 for information or the like, the support 3 being arranged in the top region of the display surface 16, with the result that the largest possible display surface 16 is made available. For this purpose, the foot 2 is preferably of approximately hoof-shaped design.

In the case of the embodiment illustrated in FIG. 3, the carrier 1 has a plate-like wall holder 17 which bears a support 3 for an accommodating clamp 4. The support 3 here is designed as a supporting angle which, on an end side of its horizontal leg which is directed toward the wall holder 17, bears hook-like protrusions 18 for suspension in corresponding openings 19 in the wall holder 17. The vertical leg of the supporting angle is of tubular design, in order for it to be possible to accommodate the accommodating clamp 4 as designed in FIGS. 1 and 2.

In the case of the embodiment illustrated in FIGS. 4 to 6, the carrier 1 is designed in the form of a column 20 with a top part 31 and a bottom part 22, the column 20 having, in particular, a polygonal, for example a hexagonal, cross section, and supports 3 designed as supporting angles being suspended, for example in accordance with the embodiment illustrated in FIG. 3, in corresponding openings in the column 20, with an accommodating clamp 4 in each case, in order for it to be possible to display a multiplicity of implements 5.

A transparent casing 23, for example a glass cylinder, is expediently arranged between the top part 21 and the bottom part 22.

It is possible here, as is illustrated in FIG. 6, for the bottom part 22 to have a foot plate 24 with an upwardly directed, inner ring 25, the ring 25 accommodating an inner tube 26. A covering 27 is inserted such that it encloses the ring 25 and covers over the foot plate 24, the column 20 being inserted with clamping action adjacent to a wall 28 of the covering 27, said wall enclosing the ring 25, at a distance therefrom, and forming a recess 29 which corresponds to the cross section of the column 20. The covering 27 is provided, adjacent to the outer circumference, with a circular groove 13 which is open at the top and is intended for accommodating the transparent casing 23. The foot plate 24 has a supporting ring 31 which supports the covering 27 in the region of the groove 30. The top part 21 is of correspondingly mirror-inverted design. It is possible here for the upright to be of rotatable design.

In the case of the embodiment illustrated in FIGS. 7 and 8, the carrier 1 may be designed in the form of a box, with a front side open or, if appropriate, provided with a front panel, there being provided a rear wall 32 with openings in which supports 3 designed as supporting angles are suspended. This mount may be used both in hanging form and in standing form.

In the case of the embodiment illustrated in FIGS. 9 and 10, the carrier 1 comprises a base plate 33 with a foot 2 which is arranged thereon, or is formed integrally with the base plate 33, and is preferably designed essentially like the exemplary embodiment illustrated in FIGS. 1 and 2, although it accommodates the tubular support 3 for an accommodating clamp 4 approximately in the center. The base plate 33 is connected to a rear wall 32.

A see-through cover 34 is expediently provided, said cover, with the base plate 33 and the rear wall 32, forming a closed box. The cover 34 is expediently accommodated adjacent to projecting frame sections 35 on the base plate 33 and the rear wall 32 and can preferably be locked to the rear wall 32. For this purpose, the cover 34 has, on the top and rear side, a protrusion 37 which is provided with a plug-through opening 36 and fits through an opening 38 in the rear wall 32. A spring catch 39 is retained on the rear side of the rear wall 32 and has a clip-like section 40 with a hook 41 for engaging in the opening 38 of the cover. The cover 34 can be released by virtue of the clip-like section 40 being pressed.

The accommodating clamp 4 expediently consists of transparent and, in particular, clear plastic.

1. A mount for displaying at least one elongate multipurpose hand-held implement (5), having a carrier (1) and an accommodating clamp (4) which is borne by said carrier and has an arm (6) which essentially follows the contour of the implement (5) and, at one end, has a nose (7) for being pushed into an opening on one end side of the implement (5) and, at the other end, has a U-shaped cradle (8) for laterally supporting the implement (5).

2. The mount as claimed in claim 1, characterized in that the accommodating clamp (4) is arranged in a rotatable manner on the carrier (1).

3. The mount as claimed in claim 1 or 2, characterized in that the accommodating clamp (4) is inclined, in relation to the horizontal, in the direction of the end bearing the nose (7).

4. The mount as claimed in one claims 1 to 3, characterized in that the U-shaped cradle (8) has legs (11) which are prestressed in relation to one another.

5. The mount as claimed in claim 4, characterized in that the legs (11) have inwardly directed noses (12) at their free ends for engaging with corresponding clearances in the implement (5).

6. The mount as claimed in one of claims 1 to 5, characterized in that the carrier (1) supports the accommodating clamp (4) approximately centrally in relation to the implement (5) retained by the same.

7. The mount as claimed in one of claims 1 to 6, characterized in that the U-shaped cradle (8) is arranged such that it engages around the implement (5) approximately in the central region thereof.

8. The mount as claimed in one claims 1 to 7, characterized in that the accommodating clamp (4) can be joined together with the carrier (1).

9. The mount as claimed in claim 8, characterized in that the accommodating clamp (4) and the carrier (1) are connected via an, in particular, latching plug-in connection.

10. The mount as claimed in one of claims 1 to 9, characterized in that the carrier (1) has a foot (2) with a support (3) for the accommodating clamp (4).

11. The mount as claimed in claim 10, characterized in that the foot (2) and support (3) can be joined together.

12. The mount as claimed in claim 10 or 11, characterized in that the support (3) is tubular.

13. The mount as claimed in one of claims 10 to 12, characterized in that the foot (2) has a sloping display surface (16), the support (3) being arranged in the top region of the display surface (16).

14. The mount as claimed in claim 13, characterized in that the foot (2) is approximately hoof-shaped.

15. The mount as claimed in one of claims 1 to 9, characterized in that the carrier (1) has a wall holder (17) of at least one support (3) for an accommodating clamp (4).

16. The mount as claimed in one of claims 1 to 9, characterized in that the carrier (1) has a column (20) with at least one support (3) for an accommodating clamp (4).

17. The mount as claimed in claim 15 or 16, characterized in that the support (3) is designed as a supporting angle.

18. The mount as claimed in one of claims 15 to 17, characterized in that it is possible for the support (3) to be suspended.

19. The mount as claimed in one of claims 16 to 18, characterized in that the column (20) has a polygonal cross section, the supports (3) being fitted on planar outer surfaces of the column (20).

20. The mount as claimed in one claims 16 to 19, characterized in that the column (20) is arranged between a top part (21) and bottom part (22) and is enclosed by a transparent casing (23).

21. The mount as claimed in claim 20, characterized in that it forms an essentially round tower.

22. The mount as claimed in one of claims 15, 17 and 18, characterized in that it is designed as a see-through box for at least one implement (5).

23. The mount as claimed in one of claims 1 to 9, characterized in that the carrier (1) is L-shaped and has a base plate (33) with rear wall (32), the base plate accommodating the support (3).

24. The mount as claimed in claim 23, characterized in that the carrier (1) has a see-through cover (34).

25. The mount as claimed in claim 24, characterized in that the cover (34), with the base plate (33) and the rear wall (32), forms a closed box.

26. The mount as claimed in claim 23 or 24, characterized in that the cover (34) can be locked to the rear wall (32).

27. The mount as claimed in one of claims 1 to 26, characterized in that the accommodating clamp (4) consists of transparent plastic.
